(19) United States
(12) Patent Application Publication
(10) Pub. No.: US 2004/0055192 A1
(43) Pub. Date: Mar. 25, 2004

(54) Light display

(76) Inventor: Tom Rowland, London (GB)

Correspondence Address: ANTHONY R BARKUME, 20 GATEWAY LANE, MANORVILLE, NY, 11949, US

(21) Appl. No.: 10/465,440

(22) Filed: Jun. 18, 2003

Related U.S. Application Data
(63) Continuation of application No. 09/631,461, filed on Aug. 3, 2000, now abandoned.

(51) Int. Cl. G09F 13/00

(52) U.S. Cl. 40/560; 40/431

(57) ABSTRACT

Equipment for producing projected visual light displays in which light from a light source is shone through a moving or rotating screen or fan and then and then through a transparent sheet onto a surface of which a substantial part of the transparent sheet is opaque and which opaque parts are distributed so that the transparent parts of the sheet are positioned in one or more separate areas, the light source is preferably elongated and shines through both sides of the fan.

### DESCRIPTION

1. Technical Field

The present invention relates to the field of light display, more particularly it relates to a light display which generates a display which is a moving, varying display of light patterns which can be generated and shone or projected onto a surface.

2. Background of Prior Art

Light displays are widely known and used in which light from a light source is shone through a moving or rotating screen or fan or other means for interrupting the light. The light can also be shone through a coloured transparent sheet to obtain coloured effects. This type of device will produce coloured flickering images which can be displayed onto the desired surface.

GB Patents 2236845 and 1024047 describe light systems for giving flame effects in imitation fuel fires, but these systems cannot be used for light displays.

I have devised improved light display equipment which gives an enhanced effect.

### DESCRIPTION OF THE INVENTION

According to the invention there is provided equipment for generating a light display which equipment comprises a light source for generating light, the light from which source passes through the blades of at least one rotatable fan and then through a transparent sheet onto a surface and in which a substantial part of the transparent sheet is opaque and which opaque parts are distributed so that the transparent parts of the sheet are positioned in one or more separate areas.

Preferably the light source is linear or is two dimensional e.g. a spot bulb or a flood bulb and is not a point light source. Preferably the dimensions of the light source are such that light can pass from either side of the light source to either side of the fan. e.g. up to three times the diameter of fan and this, combined with the gaps, gives its own flame effects adding to cross over effects. Preferably the light source has a linear dimension which is from one seventh to four times the diameter of the fan e.g. is of the same order as the fan. This will cause light from the source to pass through either side of the fan so that, as the fan rotates it will pass through blades which are rotating in an opposite sense to each other and the light will then interact to cause varying patterns.

In place of a fan any device which has the equivalent effect to the fan can be used.

The fan is preferably a multi bladed fan e.g. with at least two blades e.g. two, three or four blades. In use the fan preferably rotates at a slow speed e.g. 0.05 to 40 r.p.m preferably up to 10 r.p.m. and more preferably 0.1 to 5 r.p.m. The speed of the fan can be varied during use.

There can be more than one fan e.g. two fans rotating at different speeds or contra-rotating.

In use light can pass through the gaps between the blades and then through a transparent part of the sheet. When the gaps between the blades are opposite each other and light passes through the same transparent section of the sheet, the light passing through the opposite sides of the fan will appear to move in an opposite sense to each other on the screen. When light passes through the same transparent section from different parts of the fan there are several sets of light projections on the screen moving in slightly different senses. These sets of projections can overlap and give rise to a range of visual effects.

The transparent sections can be formed of a transparent material or can be gaps in the surrounding opaque material.

The transparent sheet preferably is coloured with various sections being the same or different colours. The opaque areas preferably occupy from 20 to 99% of the area of the transparent sheet and they can be arranged so that there are several discrete areas of opaqueness or in which some of the opaque areas are interconnected and in general occupy of the area. In general the more powerful the light source the larger the area of opaqueness.

The preferred configuration is in the form of small discrete areas of transparency.

Preferably the light from the source is directed at an angle to the axis of rotation of the fan although light shining substantially along the axis of the fan can be used and the plane of the transparent sheet is preferably at an angle to the axis of rotation of the fan or fans e.g. from 0 to 175 degrees and more preferably 0 to 60 degrees.

The fan can be offset from its axis so the projected light images will appear to precess over the screen adding to the range of effects.

The distance between the light source and the fan is preferably from adjacent the fan to the order of fifteen times the diameter of the fan and the distance from the fan to the transparent sheet is preferably of from adjacent to fifteen times the diameter of the fan.

The improved unexpected visual effects are believed to derive in some measure from light from the light source passing through both side as of the fan so that light passes through contra-rotating parts of the fan e.g. the maximum dimensions of the light source is from half the diameter of the fan.

There can be a lens inserted along the light path e.g. between the light source and the fan, between the fan and the transparent sheet or after the sheet to give the effect of a larger light source at the fan or to change the effect obtained. The lens may incorporate or be made of a textured or patterned glass and can also be rotated and any lens which can focus, enhance, diffract or otherwise change the light as it passes through can be used.

Preferably the plane of the transparent sheet is at an angle to the axis of rotation of the fan. One configuration is in the from of a pyramid or truncated pyramid e.g. with four sides with the transparent sheet forming part of one side, but this is not critical as any shape of configuration can be used to house the device, this enables decorative and artistic designs of housing to be used.

In one embodiment there is a sheet of opaque material having sections removed to allow the light to pass and there is a transparent sheet adjacent to the sheet of the opaque material, this sheet of transparent material can be coloured or have coloured sections e.g. in the form of coloured patterns etc. which can enhance the visual display effect.

The light source can also optionally be coloured.

The fan can be offset from its axis so the projected light images will appear to precess over the screen adding to the range of effects.

### DESCRIPTION OF THE DRAWINGS

The invention is described in the drawings in which:

FIG. 1 is a diagrammatic side view of the invention and

FIG. 2 is a view of the transparent sheet

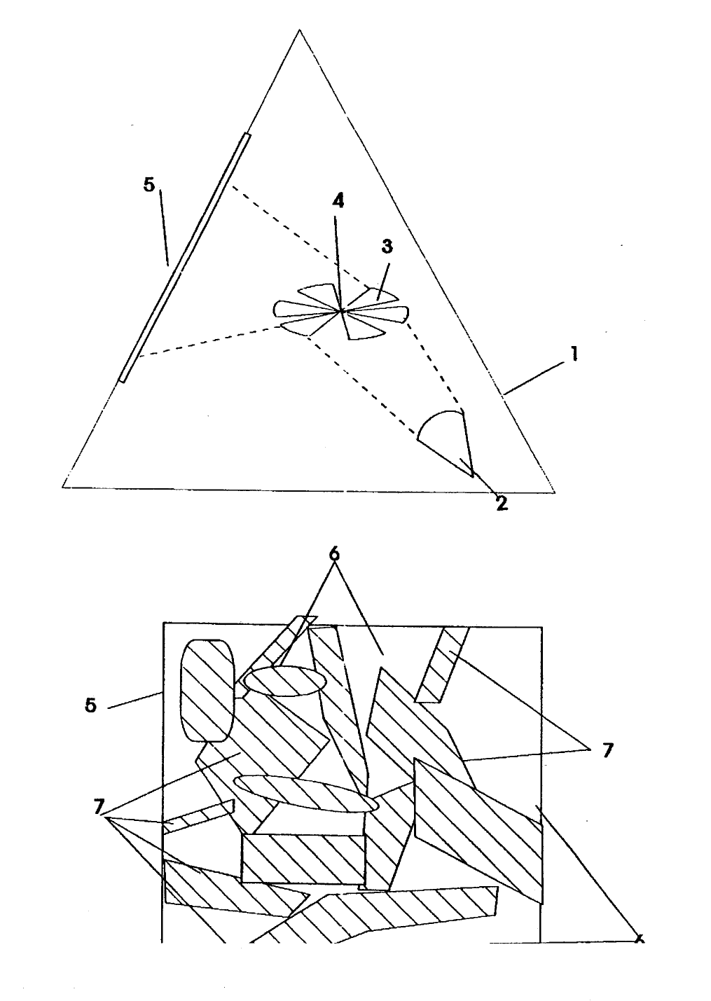

Referring to FIG. 1 a pyramid shaped container (1) contains within it a light source (2) which is an electric spotlight. There is a fan (3) made of metallic light reflective material which rotates about a substantially horizontal axis (4). There is a transparent window (5) which contains transparent areas of coloured plastics material (6) and opaque areas (7) (FIG. 2). The sides of the pyramid (1) are opaque.

In use the light source (2) is turned on and the fan (3) rotates at about one r.p.m. and light shines through the fan and out of window (5), light projected onto a wall or screen shows a slowly changing variety of patterns of great complexity of form and colour.

1. Equipment for generating a light display which equipment comprises sequentially (i) a light source for generating light, (ii) at least one rotatable fan and (iii) a partially transparent sheet in which a substantial part of the transparent sheet is opaque and which opaque parts are distributed so that the transparent parts of the sheet are positioned in one or more separate areas; light from the light source passing sequentially through the blades of the rotatable fan and the transparent sheet onto a display surface.

2. Equipment as claimed in claim 1 in which the light source is two dimensional and the light source has a linear dimension which is from one seventh to four times the diameter of the fan.

3. Equipment as claimed in claim 1 in which the light source is two dimensional and the light source has a linear dimension which is of the same order as the fan.

4. Equipment as claimed in claim 1 in which the fan is a multi bladed fan with at least two blades.

5. Equipment as claimed in any claim 2 in which the transparent sheet is coloured with various sections being the same or different colours.

6. Equipment as claimed in claim 1 in which the light from the source is directed at an angle to the axis of rotation of the fan.

7. Equipment as claimed in claim 2 in which the plane of the transparent sheet is at an angle of 0 to 60 degrees to the axis of rotation of the fan.

8. Equipment as claimed in claim 1 in which there are two contra-rotating fans.

9. Equipment as claimed in claim 1 in which the distance between the light source and the fan is from adjacent the fan to the order of fifteen times the diameter of the fan and the distance from the fan to the transparent sheet is from adjacent to fifteen times the diameter of the fan.

10. Equipment as claimed in claim 1 in which there is a lens positioned in the light path between the light source and the display surface.

11. Equipment as claimed in claim 8 in which the plane of the transparent sheet is at an angle to the axis of rotation of the fan.

12. Equipment as claimed in claim 1 in which the light display means is within a housing in the from of a pyramid or truncated pyramid, with four sides with the transparent sheet forming part of one side.

13. Equipment as claimed in claim 8 in which the light display means is within a housing in the from of a pyramid or truncated pyramid, with four sides with the transparent sheet forming part of one side.
